(19) United States
(12) Patent Application Publication
(10) Pub. No.: US 2015/0106179 A1
(43) Pub. Date: Apr. 16, 2015

(54) ADVERTISING AND PROMOTION METHOD AND SYSTEM

(71) Applicants: Edmond Kwok-Keung Chow, Hong Kong (HK); Elina Yuen-Wai Luk, Hong Kong (HK)

(72) Inventors: Edmond Kwok-Keung Chow, Hong Kong (HK); Elina Yuen-Wai Luk, Hong Kong (HK)

(21) Appl. No.: 14/515,280

(22) Filed: Oct. 15, 2014

Related U.S. Application Data
(60) Provisional application No. 61/891,414, filed on Oct. 16, 2013.
(60) Provisional application No. 62/063,358, filed on Oct. 13, 2014.

(51) Int. Cl. G06Q 30/02

(52) U.S. Cl. CPC G06Q 30/0215
USPC 705/14.17

(57) ABSTRACT

An advertising and rewarding system, method, and process are provided. Among its various embodiments and enabling features, an embodiment may guarantee a lower price for an item of interest than what a consumer is willing or committed to pay.

### CROSS REFERENCE TO RELATED APPLICATIONS

The present application claims benefit under 35 U.S.C. §119(e) of U.S. Provisional Patent Application No. 61/891,414, filed Oct. 16, 2013, and U.S. Provisional Patent Application No. 62/063,358, filed Oct. 13, 2014. Content of all of the above applications is incorporated herein by reference in its entirety.

### TECHNICAL FIELD

This invention relates to methods, processes, apparatuses and systems for advertising and promotion.

### BACKGROUND

Sellers, manufacturers, brands, businesses, and marketplaces alike might be reluctant to make available a low price for a product or service even in a competitive market or environment. The reasons may include not wanting to trigger price-cutting competitions from competitors, restrictions from suppliers or wholesalers (e.g., minimum advertised pricing agreements), and fear of brand image dilution. Some solutions in the art may include hiding the low price until a consumer adds the product to his online shopping cart, or asking the consumer to make a further inquiry to have the low price revealed. However, such approaches still reveal the low price enabling him to price compare before purchase, while imposing on him what might amount to an extraneous effort. In addition, an advertising scheme in the art may involve giving out discount coupons for future purchases after a sales transaction. However, such discount coupons provide, if any, little or weak association as discounts to the purchase that might have resulted in their availability to the customer. That is, consumers who receive these discount coupons do not in general regard it as money lost if these discount coupons are not used by themselves or their friends and family. For instance, they may still think that they paid the actual price for the product in the sales transaction that resulted in the discount coupon, and the discount from the coupon is simply an incentive for them to spend at the shop or marketplace later, as is the case if they had received the discount coupon in the mail without any prior purchases. Yet another advertising scheme involves giving prospective customers at the store a coupon (e.g., a so-called “scratch-and-save” coupon) whose discount is initially concealed and may vary from one customer to another. The customers may then have the coupon amount (and its terms and conditions) revealed prior to their purchases. That is, such a discount may be made known to the customers prior to any commitment to pay from the customers. In addition, it may be determined without the customers having chosen a particular item or group of items of interest. As such, this scheme is more like a draw or lottery for a store discount, rather than a hidden discount associated with a particular item or group of items.

The present invention addresses these problems, and provides other benefits, including but not limited to customers retention.

### SUMMARY

In accordance with one aspect of the present invention or one of its embodiments, there is provided a method for advertising an item for sale. The method, which may be computerized or executed on, in, or by one or more databases and/or computers such as a database computer system, may involve associating a first price with the item (e.g., assigning a listed or discounted price to a product or service); presenting to a user an indication of the item and an indication of the first price (e.g., displaying the product or service along with the listed or discounted price on a webpage, whether in response to a query from the user or not); associating in the database the user with an account (e.g., identifying the user as having a registered account, such as after he has successfully signed up or logged in, or based on some pre-existing or system-provided information, e.g., cached information in an internet browser cookie); determining a first amount based at least in part on the first price, wherein the first amount is equal to or more than the first price (e.g., arriving a first total that includes the listed or discounted price, and sale taxes); associating a second price with the item, wherein the second price is lower than the first price (e.g., applying a percentage of discount based on the listed or discounted price); receiving a commitment to pay for the first amount, wherein the user does not know the second price (e.g., receiving credit card information for the user with authorization to charge at least the amount of the first total, without disclosing the further discounted price to the user); determining a second amount based at least in part on the second price, wherein the second amount is equal to or more than the second price (e.g., arriving a second total that includes the further discounted price, and sale taxes); determining a credit based at least in part on the first amount and the second amount (e.g., calculating the difference between the first total and the second total); and associating in the database the credit with the account (e.g., crediting the user's account with the amount of the calculated difference).

In another embodiment, the commitment to pay may include an amount based on a total price and the discount (e.g., a difference between the actual charge and the amount) may be a percentage of the amount. In another embodiment, a credit or saving resulting from the commitment to pay, the exact amount of the credit or saving not being made known to the customer prior to his commitment to pay, enables the customer to purchase another item using the credit or saving, as long as his account is active. That is, it does not expire while his account is active. In one embodiment, such a credit or saving is made available to the account of the customer, for example, until the next statement date, after the amount has been made known to him (e.g., via an electronic receipt or statement). In another embodiment, such a credit or saving is made known to the customer, e.g., until the next statement date, after the commitment to pay has been received and/or processed.

In accordance with another aspect of the present invention or one of its embodiments, there is provided a method, which may be computerized or executed on, in, or by one or more databases or computers such as a database computer system, may involve associating in a database a first price with an item (e.g., storing information for an item and its first price in a database); determining a second price for the item, wherein the second price is lower than the first price (e.g., storing information for a second price in the database, and associating the second price information such as a price or a discount with the item, the resultant second price being lower than the first price); presenting to a user an indication of the item and an indication of the first price (e.g., causing a device to display a webpage, the webpage showing the item and the first price, and the device being associated with or coupled to the user); determining a first amount based at least in part on the first price, wherein the first amount is equal to or greater than the first price (e.g., calculating a first total amount based on the first price and whether sale taxes are applicable); determining a second amount based at least in part on the second price, wherein the second amount is less than the first amount (e.g., calculating a second total amount based on the second price and whether sale taxes are applicable); receiving a commitment to pay the first amount, wherein the user does not know the second price (e.g., receiving credit card information for the user with authorization to charge at least the amount of the first total amount, without disclosing the second price or the second total amount to the user); and in response to receiving the commitment to pay for the first amount, charging the user the second amount (e.g., charging the user the second total amount based on the credit card information for the user).

In accordance with yet another aspect of the present invention or one of its embodiments, there is provided a method, which may be computerized or executed on, in, or by one or more databases or computers such as a database computer system, may involve associating in a database a first price with an item (e.g., storing in a database a record comprising information for an item and its first price); associating in the database a second price or a discount with the item, wherein the second price is lower than the first price, or the discount is in relation to the first price (e.g., storing in the database a record comprising information for a second price and associating the second price information with the item, wherein the resultant second price is lower than the first price); presenting to a user an indication of the item and an indication of the first price (e.g., in response to a user's input, query, or gesture, sending a device a representation of data pertaining to the item and its first price, the device being associated with or computed to a user, and being capable of presenting the user a description of the item and its first price based on the representation of the data); receiving from the user an indication of payment for the item, wherein the user does not know the second price or the discount (e.g., receiving credit card information for the user with authorization to charge at least the amount of the first price, without disclosing the second price information or the resultant second price to the user); in response to receiving the indication of payment for the item, generating a message, wherein the message associates the second price or the discount with the item (e.g., in response to receiving the credit card information for the user, generating a sale receipt that shows the resultant second price and associates it with the item); and presenting the message to the user (e.g., printing the sale receipt in front of the user, or sending the user device a representation of data pertaining to the item and the resultant second price, the device being capable of presenting the user an identification of the item and the resultant second price based on the representation of the data).

Other aspects and features of the present invention or its embodiments will become apparent to those ordinarily skilled in the art upon review of the following description of specific embodiments of the invention in conjunction with the accompanying figures.

### BRIEF DESCRIPTION OF THE DRAWINGS

FIG. 1 illustrates an example environment for an embodiment of the present invention.

FIG. 2 illustrates a block diagram of an example advertising system in accordance with an embodiment of the present invention.

FIG. 3 illustrates a block diagram of an example credit server in accordance with an embodiment of the present invention.

FIG. 4 illustrates a block diagram of a processor system implementing an example advertising system comprising an example credit server in accordance with an embodiment of the present invention.

FIG. 5 illustrates an example presentation or screenshot of indications of a retail item, an advertised price, and an unknown lower price on a device coupled to a user, such as those coupled to the users as shown in FIG. 1, in accordance with an embodiment of the present invention.

FIG. 6 illustrates an example presentation or screenshot of a record on a device coupled to a user, such as those coupled to the users as shown in FIG. 1, in accordance with an embodiment of the present invention.

FIG. 7 illustrates a flow of an example process for advertising a retail item for sale, such as one that may be executed on, in, or by an advertising system like the one shown in FIG. 1, in accordance with an embodiment of the present invention.

FIG. 8 illustrates a flow of another example process for advertising a retail item for sale, such as one that may be executed on, in, or by an advertising system like the one shown in FIG. 1, in accordance with an embodiment of the present invention.

FIG. 9 illustrates a flow of yet another example process for advertising a retail item for sale, such as one that may be executed on, in, or by an advertising system like the one shown in FIG. 1, in accordance with an embodiment of the present invention.

FIG. 10 illustrates a flow of yet another example process for identifying a payer on a receipt, in accordance with an embodiment of the present invention.

FIG. 11 illustrates a flow of yet another example process for revoking a credential, in accordance with an embodiment of the present invention.

### DETAILED DESCRIPTION

A method, process, and system for advertising an item or offer are provided. An item may be a product, service, event, activity, food and beverage, digital goods, artifact, or anything that may be owned, experienced, bought, auctioned, bartered, exchanged, or transferred.

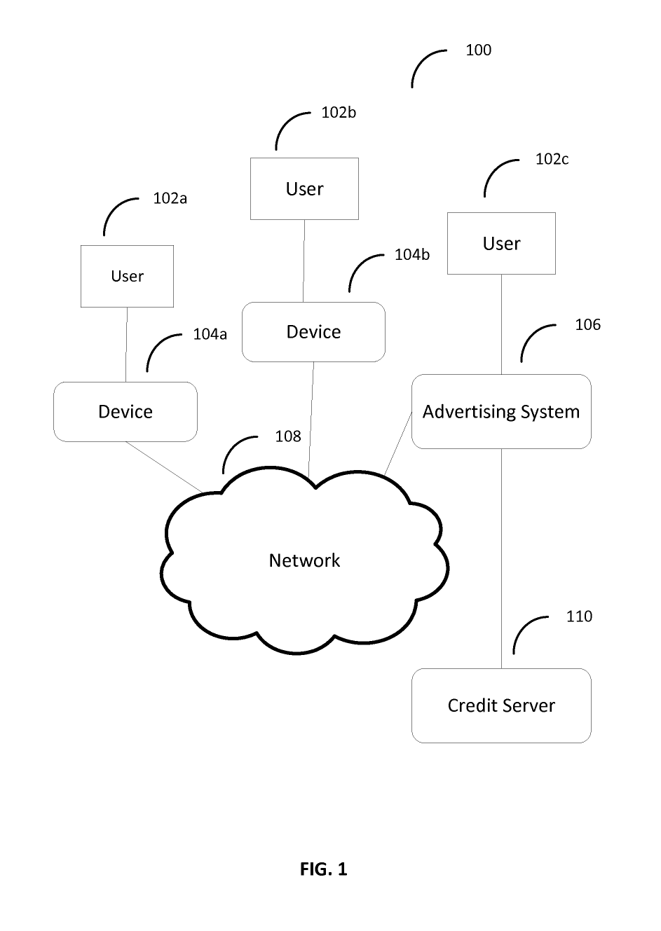

FIG. 1 illustrates an example environment 100 for advertising an item. A plurality of users 102a and 102b may receive information about an item and its price and provide a commitment to pay for the item, at their respective devices 104a and 104b, which are communicatively coupled to an advertising system 106 via a network 108 such as the Internet. (And any type of network is within the scope of various embodiments.) The advertising system 106 may comprise any entity that may participate in the process of making known an item to a consumer, facilitating his interest for the item, or effecting his commitment to pay for the item. It may include any system that presents one or more items to a prospective customer, whether in response to his query or not. For example, the advertising system may include a search service that accepts queries or requests about a product or seller from one or more users through a device such as a computer, a terminal, or mobile phone, and presents the one or more users with responses pertaining to the product or one or more products and offers associated with the seller. The mode of such queries, requests or responses may be textual, visual, audio, tactile, or anything communicable to or perceivable by the users. In addition, the advertising system 108 may act as a gateway or proxy to item or offer information available at or accessible through another advertising system (not shown), to which the advertising system may be coupled directly or via a network. The example environment 100 may also comprise a user 102c that is communicatively coupled to or otherwise capable of interacting with the advertising system 108 without an intermediary device.

A credit server 110 is communicatively coupled to the advertising system 106. The credit server 110 maintains information, such as credit information, in relation to lower prices that are associated with items known via the advertising system 106. According to one embodiment, such lower prices and their resultant payable totals (e.g., a total including sale taxes and shipping fees) are not revealed to a customer until the advertising system 106 or the credit server 110 receives a commitment from the customer to pay for the publicly-known prices for the items in question. According to one embodiment, a credit may be calculated or otherwise determined based on a publicly-known price of an item and a lower price for the item, the lower price not being known to a customer (e.g., user 102a) until the advertising system 106 or credit server 110 receives a commitment to pay for an amount in relation to the publicly-known price. According to one embodiment, such a credit may be assigned to one or more accounts associated with the advertising system 106, the credit server 110, or a database server or system (not shown in FIG. 1), the one or more accounts being associated with the customer (e.g., user 102a), a group of users (e.g., users 102a and 102b), and/or a third party (e.g., a cause or charity). According to another embodiment, such a credit may be associated with a transaction, activity, or event. For example, such a credit may result in a lower amount (when compared to one that is based on a publicly-known price) being charged or chargeable to the customer (e.g., user 102a), in relation to a purchase, checkout, and sales event. (All methods or modes of checkout, such as online, in-person, and pre-authorized, are within the scope of various embodiments.)

For instance, according to one embodiment, the user 102a may visit via his coupled device 104a a website (e.g., the advertising system 106) which presents information about an item for sale, the information comprising an identification of the item and a price for the item. The website may maintain such information, or may retrieve it (synchronously, periodically, on demand, etc.) from another website or system. The website (e.g., the advertising system 106 comprising the credit server 110), or a server or system (e.g., the credit server 110) accessible to the website, may maintain lower price information for the item, and conceal the lower price information from the user 102a. The website or the server or system may calculate or otherwise determine an amount, namely a saving amount, based on the price information and the lower price information (e.g., a difference between the price and the lower price, or a difference between two sums, each based on the price and the lower price respectively). The website, the server or system, or another server or system communicatively coupled to the website and/or the server or system, may receive from the user 102a a commitment to pay for the price associated with the item (e.g., the user 102a submitting credit information to the website, or authorizing the website to charge an existing account, for an amount sufficient to account for or cover the price). In response to receiving the commitment to pay, the website or the server or system may discount the item based on the saving amount, or reward or otherwise associate the saving amount to or with the user 102a. In one embodiment, the website or the server or system may identify the user 102a as a registered user via login or some other methods of user identification, and associate the saving amount with an account of the identified user. Such an account may be maintained by the website or the server or system, or another server or system communicatively coupled to the website and/or the server or system. (All methods or modes of payment or payment commitment, such as one-click ordering, and all methods or modes of user identification, such as user logon, are within the scope of various embodiments.)

According to another embodiment, the user 102a may visit via his coupled device 104a an online system (e.g., the advertising system 106 comprising the credit server 110) that may present a human-machine interface that accepts a query or web address. In response to receiving input from the user 102a, the online system may present information about an item for sale, the information comprising an identification of the item and a first price for the item. The online system may associate a second price with the item, the second price being not available to the user 102a before the online system (or a proxy) has received a commitment to pay for the item from the user 102a. In one embodiment, the online system may determine the second price based on a discount common to all customers. In another embodiment, the online system may determine the second price based on time (e.g., the time of day, a time interval, the days of the week, a calendar time range), account (e.g., discount rates associated with a user or user account), and/or items (e.g., specific items, combinations of specific items, quantity of items). The user 102a may indicate to the online system a commitment to pay for the item (e.g., providing a payment of at least the amount equal to the first price, or information enabling payment for at least the amount equal to the first price), while not knowing the second price. In response to receiving the commitment to pay, the online system may charge the user 102a an amount based on the second price, resulting in a lower cost to the user 102a compared to a cost based on the first price.

According to yet another embodiment, a user (e.g., the user 102c) may be coupled to a point-of-sale (POS) system equipped with an embodiment of the present invention (e.g., the advertising system 106 comprising the credit server 110) without the need of a network (e.g., the network 108) or an intermediary device (e.g., the devices 104a and 104b). For example, the user may present a retail item at a POS system or its frontend (e.g., a self-checkout terminal). The POS system may display a first price to the user in relation to the item, and indicate that a lower price may be available to the user or for the item without showing the actual amount of or discount for the lower price, wherein the lower price may be determined before, at, or after the presentation of the first price. The user may submit to the POS system a payment (e.g., via cash, debit card, credit card, an online account) to account for a sum based on the first price. In one embodiment, the POS system may charge an amount based on the lower price, the amount being lower than the sum that is based on the first price, in response to receiving the payment submission. In another embodiment, the POS system may generate and present a message (e.g., a sale receipt) that reveals the lower price, a discount associated with the lower price, or a sum based on the lower price, and associates it with the item. In one embodiment, the POS system may refund the difference (e.g., a cash refund) between the amount based on the lower price and the sum based on the first price. In another embodiment, the POS system may charge a lesser amount (i.e., based on the lower price) against the payment or payment information so that there is no subsequent refund or credit to account. In one embodiment, an operator of or a third party to the POS system may interact with the POS system on behalf of the user or this transaction.

According to other embodiments, the advertising system 106 may comprise the credit server 110, or the credit server 110 may comprise a module or component associated with the advertising system 106.

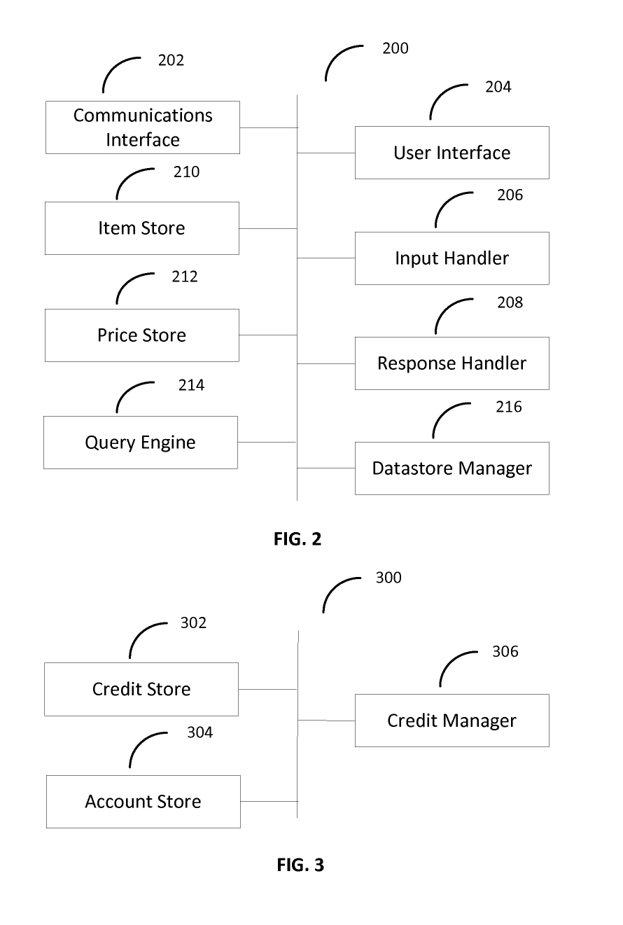

Referring to FIG. 2, a block diagram of an example advertising system 200, such as the advertising system 106 illustrated in FIG. 1, is shown. The example advertising system 200 may comprise a communications interface 202, a user interface 204, an input handler 206, a response handler 208, an item store 210, a price store 212, a query engine 214, and a datastore manager 216.

The communications interface 202 is provided for communicating with devices over a communications medium, such as the devices 104a and 104b and the network 108 shown in FIG. 1. These devices communicate with the advertising system 200 via the communications interface 202 utilizing various modes of delivery of data or messages, such as requests, submissions, responses, and notifications. Examples of such requests and submissions include login credentials, web addresses, queries, navigation commands or gestures, payment information, and so on. Examples of such responses and notifications include search results or parts thereof, item and price information, account information, error messages, and so on. Any type of communications interface or mode of delivery is within the scope of various embodiments.

The user interface 204 is provided for communicating with a user, such as via the devices 104a and 104b described herein. It is configured to interact with the user to obtain his input as well as presenting output to him. For instance, it may be configured to communicate with a display engine or graphical user interface included in the devices 104a and 104b that are coupled to the users 102a and 102b. It may also comprise a display engine or graphical user interface capable of accepting and presenting information from and to the users 102a, 102b and 102c, whether the information is graphical, textual, audio, or any other mode of communication. For example, the user interface 204 may present a search input box with which the user 102a types in their query, accept the query, and present information entries in response to the query. Data or messages between the user 102a and the user interface 204 are delivered via the communications interface 202. Any type of user interface is within the scope of various embodiments.

The input handler 206 is provided for processing requests and submissions. For instance, it may interpret requests received by the user interface 204 from the user or the device, and direct or otherwise cause other components or modules in the advertising system to fulfill those requests. Examples of such requests may include a query, a webpage, account login, payment and so on. For example, the input handler 206 may cause the datastore manager 216 to store price information in the price store 212 in relation to one or more items maintained in the item store 210. For a query request, the input handler 206 may cause the query engine 214 and response handler 208 to process the query and respond to the user or the device via the user interface 204. In one embodiment, the query engine 214 may interface or interact with a third-party system to retrieve information of interest, e.g. item information and price information. According to one embodiment, the input handler 206 may for some requests respond to the device or the user via the communications interface 202 or user interface 204. Examples of this type of requests include item description, seller description, payment registration, and so on. The input handler may also generate inter-component or inter-module instructions based on or in response to incoming requests or submitted information. In one embodiment, the response handler 208 may perform or prepare information retrieval, processing (e.g., arithmetic), and presentation without direct stimuli or input from a user.

The response handler 208 is provided for preparing data for delivery to the device via the communications interface 202 and for presentation to the user via the user interface. For instance, it may cause the query engine 214 to retrieve requested information (e.g., a list of items, prices, or offers) as well as other relevant information (e.g., indications of availability of a second or lower price) when it receives instructions from the input handler 206 to process a query. After receiving the results from the query engine 214, the response handler 208 may select an initial or partial set of the results and present to the user via the user interface 204 a response comprising this set. It may also include as part of the response a reference such as a URL with which the user may obtain another set of the results via the user interface 204. In some embodiments, the user interface 204 may cause the response handler 208 to process this request for the other set of results without involving the input handler 206. The response handler 208 may then cause the query engine 214 to retrieve the other set of results. According to other embodiments, the user interface 204 may cause the datastore manager 216 to retrieve the other set of results. The response handler 208 may also interact with a credit server, such as the credit server 110 shown in FIG. 1, to retrieve additional information or references to additional information (such as lower price information and/or credit information associated with an item and/or account) and make them available as part of the response for delivery and presentation to the device and the user.

The item store 210 is provided for storing information about items, including but not limited to item identifications, item descriptions, and sellers and locations for the items. The information and their related data may be stored, modified, added and so forth to any storage medium. According to one embodiment, the item store may include at least one index for the information records or entries available therein.

The price store 212 is provided for storing information pertaining to prices or offers in relation to items, including but not limited to prices or offers related to the items maintained in or by the item store 210. It may also maintain an association of prices or offers available therein with items and/or sellers available via the item store 210. According to one embodiment, the price store 212 may include at least one index for the information records or entries available therein.

The datastore manager 216 is provided for maintaining, organizing and operating the item store 210 and price store 212. Other modules or components may communicate with the datastore manager 216 for access to the item store 210 and price store 212. In one embodiment, other modules or components such as the query engine 214 may access directly the item store 210 and price store 212 to obtain specific information entries or search their respective indexes. In some embodiments, the datastore manager 216 may include an indexing component or module that indexes the information entries or records available in the item store 210 and price store 212 and facilitate fast retrieval for those information entries or records. It may maintain and store such indexes in a separate store (not shown).

The query engine 214 is provided for handling queries for item, seller, price, and offer information and related data or metadata. It may interpret or validate the queries and provide results to the queries as well as other data pertaining to the queries or results. For example, the query engine 214 may include in its response the size of the available results and the searching time associated with a query. It may communicate with the datastore manager 216 for access to the item store 210 and price store 212 where the information records or entries and their related data or metadata are stored. In some embodiments, the query engine 214 may access the item store 210 and price store 212 without involving the datastore manager 216 as an intermediary.

Although the advertising system 200 is described as being comprised of various components or modules (the communications interface 202, user interface 204, input handler 206, response handler 208, item store 210, price store 212, query engine 214, and datastore manager 216), fewer or more components or modules may comprise the advertising system 200 and still fall within the scope of various embodiments. For example, the datastore manager 216 may comprise the query engine 214. The item store 210 may comprise the price store 212. The input handler 206 may comprise the user interface 204, or the user interface 204 may be omitted (e.g., when the device provides the full user interface capability and communicates directly with the input handler 206). The input handler 206 may comprise the response handler 208. The response handler 208 may comprise the query engine 214 and datastore manager 216. The user interface 204 may comprise both the input handler 206 and response handler 208. And so on.

In one embodiment, the credit server 110 shown in FIG. 1 is configured to maintain, determine, and manipulate credit or discount information associated with items, sellers, users, prices, transactions, etc. that may be maintained in a database (e.g., the item store 210, the price store 212, the credit server 110, or any server accessible to the advertising server 106 or the credit server 110). The credit server 110 may handle requests or instructions for accepting submissions of these indications or representations, and retrieving the same. For example, the credit server 110 may receive a payment or payment commitment request from the query engine 214 or response handler 206, and deliver indications of discounts, lower prices, or lower total charges in response to the request. It may receive a payment or payment commitment request from the input handler 206, and calculate or retrieve discounts, lower prices, or lower total charges in response to the request. It may also process a payment or payment commitment (e.g., accepting the payment, charging against the payment commitment, and/or assigning and storing credit information for each user account), and generate a message or record that reveals the lower price or discount information for an item.

Referring to FIG. 3, a block diagram of an example credit server 300, such as the credit server 110 illustrated in FIG. 1, is shown. The example credit server 300 may comprises a credit store 302, an account store 304, and a credit manager 306.

The credit store 302 is provided for storing information associated with credit, lower price, or discount information and/or its formula that may be made available to items stored in the item store 210. It may also store metadata associated with this information. In one embodiment, indications, representations, or determinations of such credit, lower price, or discount information and/or its formula may be created or maintained outside of the credit store 302, the credit server 300, or the environment 100. For example, a third-party database or server (not shown) may be used to provide for these indications, representations, or determinations. Alternatively, the credit store 302 may be located externally or remotely and accessed by the advertising system 200 or the credit server 300 over a network. In another embodiment, the credit store may be part of or directly coupled to the advertising system 200. For example, other components may access the credit store 302 directly, or via the datastore manager 216.

The account store 304 is provided for storing information pertaining to accounts associated with users, organizations, events, and so on. It may store and maintain user account information as well as activities related to a user account, including but not limited to user identity, credit balance, purchase history, user-specific discounts, and group affiliations.

The credit manager 306 is provided for maintaining, organizing and operating the account store 304 and credit store 302. Other modules or components communicate with the credit manager 306 for access to these stores, such as retrieving discount or credit information for an item, a transaction, or an account. In one embodiment, the credit manager 306 may include an indexing component or module that indexes data available in the account store 304 and credit store 302, and facilitate fast information retrieval for the data. It may maintain such indexes in their respective stores, and in another store (not shown). In some embodiments, the credit manager 306 is operably configured to cause the query engine 214 to search the account store 304 and credit store 302.

Although the credit server 300 is described as being comprised of various components or modules (the account store 304, credit store 302, and credit manager 306), fewer or more components or modules may comprise the credit server 300 and still fall within the scope of various embodiments. For example, the credit store 302 may comprise the account store 304. Or the advertising system 200 may comprise the credit server 300 (e.g., the datastore manager 216 may comprise the credit manager 306 and the advertising server 200 may comprise a data store (not shown) that comprises the account store 304 and credit store 302). In addition, functions or data associated with the credit store 302 may instead be performed or maintained with a component in the advertising server 200. For example, the price store 212 may store information or formula for lower prices for an item, and the credit manager 306 may access the price store 212 instead of or in addition to the credit store 302.

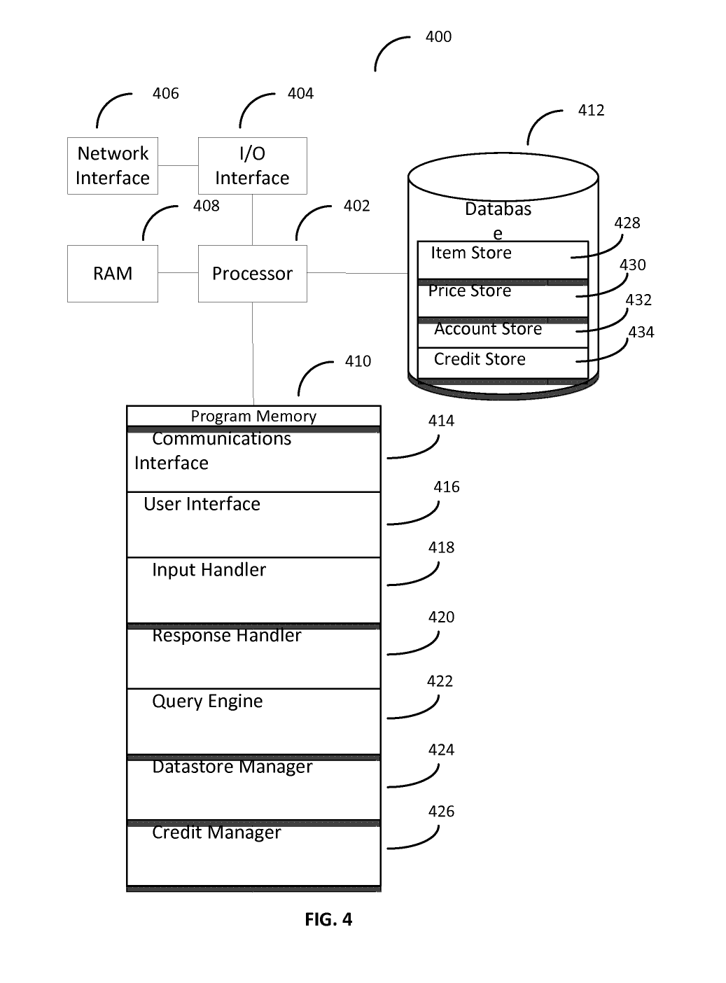

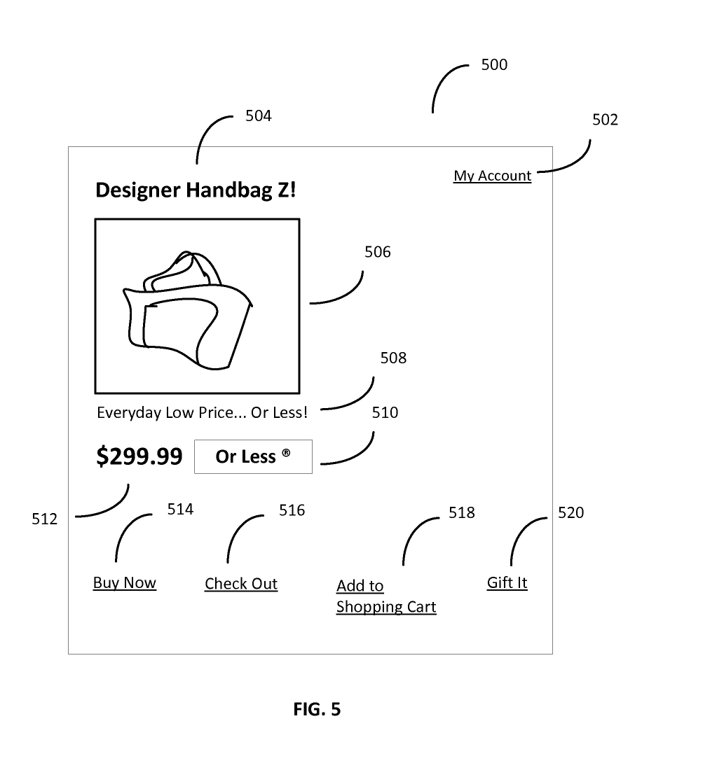

Referring to FIG. 4, a general block diagram of a processor system 400 implementing an advertising system comprising a credit server, such as the example advertising system 200 and the example credit server 300 illustrated in FIG. 2 and FIG. 3 respectively, is shown. Generally, in the embodiment shown, the processor system 400 includes a processor circuit comprising a processor 402, and an input/output (I/O) interface 404 to which a network interface 406 is coupled. The processor 402 is also in communication with random access memory (RAM) 408, program memory 410, and database memory 412. The processor 402 controls the database memory 412 under the direction of a general database manager, a specialized database manager, a combination thereof (herein referred to as a hybrid database manager), or a collection of database managers, implemented in codes stored in the program memory 410) that direct the processor 402 to perform database management functions to maintain one or more databases of data records in the database memory 412.

The term “processor system” has been used to indicate that the processor circuit shown in FIG. 4 is only one of a plurality of implementations and configurations and that, for example, the processor system 400 may employ a plurality of processors locally or geographically distributed to effect the functions described below that are performed by the processor system 400. The processor system 400 may be configured to contain fewer or more components. For example, the RAM 408 may comprise parts of or the entire database. Or the general database manager, the specialized database manager, the hybrid database manager, or the collection of database managers may include codes that direct the processor 402 to communication with a database located remotely from the advertising system. The remotely located database could be a commercial database, for instance, and the advertising system may merely be configured to interact with such database without requiring substantial memory or detailed database management functionality at the advertising system. A terminal interface (not shown) may be connected to the I/O interface 404 for direct interaction with users. Or the I/O interface may comprise the network interface 406. The processor system 400 may comprise a plurality of distributed processors, program memories, and databases coupled over a network. Or it may comprise a plurality of processor subsystems each capable of operating as a standalone processor system.

In one embodiment, to enable an advertising system (such as the advertising system 106 shown in FIG. 1) to present item information to a user and to accept a payment commitment for the item while not disclosing a lower price associated with the item, the program memory 410 may include the following components or modules: a communications interface 414 (such as the one 202 shown in FIG. 2, and being operably configured to perform its functionality as described above), a user interface 416 (such as the one 204 shown in FIG. 2, and being operably configured to perform its functionality as described above), an input handler 418 (such as the one 206 shown in FIG. 2, and being operably configured to perform its functionality as described above), a response handler 420 (such as the one 208 shown in FIG. 2, and being operably configured to perform its functionality as described above), a query engine 422 (such as the one 214 shown in FIG. 2, and being operably configured to perform its functionality as described above), a datastore manager 424 (such as the one 216 shown in FIG. 2, and being operably configured to perform its functionality as described above), and a credit manager 426 (such as the one 306 shown in FIG. 3, and being operably configured to perform its functionality as described above. The database 412 includes the following storages or repositories of data records or entries: item store 428 (such as the item store 210 shown in FIG. 2, and being operably configured to perform its functionality as described above), price store 430 (such as the price store 212 shown in FIG. 2, and being operably configured to perform its functionality as described above), account store 432 (such as the account store 304 shown in FIG. 3, and being operably configured to perform its functionality as described above), and credit store 434 (such as the credit store 302 shown in FIG. 3, and being operably configured to perform its functionality as described above).

For instance, in one embodiment, the communications interface 414 (e.g., HyperText Transport Protocol interface) is operably configured to direct an advertising system (such as the advertising system 106 shown in FIG. 1) to send and receive data and messages over a network via the I/O interface 404 (e.g., Transport Control Protocol port interface) coupled to the network interface 406 (e.g., Internet Protocol network interface). The user interface 416 is operably configured to cause the advertising system to accept requests and submissions from and present responses and notifications to users via devices coupled to the users (such as the devices 104a and 104b and the users 102a and 102b shown in FIG. 1). The input handler 418 is operably configured to cause the advertising system to process and interpret requests and submission (e.g., a query for item information or an input leading to item information; a request for a webpage or purchase of one or one items; and a submission for credit card information or payment authorization). The response handler 420 is operably configured to cause the advertising system to prepare results in response to user requests, and make them available to the users via the user interface 416. Such results may include a webpage of item and price information, a message of purchase or payment confirmation, and a sale record or receipt. The query engine 422 is operably configured to cause the advertising system to initiate a search of the item store 428 and price store 430 for information entries that meets criteria set forth in user requests or requests from other components or modules. (In one embodiment, the query engine 422 is also operably configured to cause the advertising system to search the account store 432 and credit store 434 in accordance with criteria set forth in user requests or requests from other components or modules.) The datastore manager 424 is operably configured to cause the advertising system to create and update data or records in the item store 428 and price store 430 for information pertaining to items and prices. The credit manager 426 is operably configured to cause the advertising system to create and update data or records in the account store 432 and credit store 434. (In one embodiment, the datastore manager 424 may also be operably configured to cause the advertising system to create and update data or records in the account store 432 and credit store 434.)

FIG. 5 is an example presentation or screenshot of indications of a retail item, an advertised price, and an unknown lower price on a device coupled to a user, such as those coupled to the users as shown in FIG. 1, in accordance with an embodiment of the present invention. At the upper right area of the presentation 500 is a hyperlink to enable a user (such as the user 102a in FIG. 1) to logon with an advertising system (such as the advertising system 400 in FIG. 4), thereby enabling the advertising system to identify the user. For example, the input handler 418 may accept logon credential and verify it against the account store 432 via the credit manager 426. The title 504 (i.e., “Designer Handbag Z!”) and the photo 506 in FIG. 5 are item information that may be stored in the item store 428 and retrieved via the datastore manager 424. The message 510 (i.e., “Everyday Low Price . . . Or Less”) may indicate that a lower price may be available, but without disclosing any amount to the user. In response to the user's activation, the clickable area 510 (i.e., a button labeled with “Or Less”) may provide information as to the rules, terms, and/or conditions on how a lower price may be disclosed to the user, and how credits or discounts may be realized, used, shared, or withdrawn by the user. The price 512 (i.e., “$299.99”) is price information that may be stored in the price store 430 and retrieved via the datastore manager 424. The clickable area or hyperlink 514 (labeled “Buy Now”) enables the user to signal his selection of the item as described in FIG. 5 and submit his payment commitment, all with the same single indication (e.g., a mouse click or hand gesture from the user), to the advertising system. To effect the payment commitment, for example, the advertising system (e.g., via the input handler 418 and the credit manager 426) may already have credit card information of the user, and identified the user via a prior successful logon. The clickable area or hyperlink 516 (labeled “Check Out”) may enable the user to confirm or change his payment method or payment commitment, as well as his selection of items. The clickable area or hyperlink 518 (labeled “Add to Shopping Cart”) enables the user to cache the selected item(s) and perform the payment process at a later time, for example, via a local store at the user's device (e.g., a cookie of the browser installed on the device), thereby delaying the user's payment commitment. The communications interface 414, user interface 416, and/or input handler 418 may be responsible for handling payment commitment indications and submissions, and their related activities. The clickable area or hyperlink 518 (labeled “Gift It”) may enable the user to provide information for a recipient of the item as gift, so to cause the advertising system to end the recipient a message notifying him the gift item and its publicly-known price (i.e., price information 512), but to disclose the lower price (not shown) only to the user, after the user has successfully paid or checked out the item.

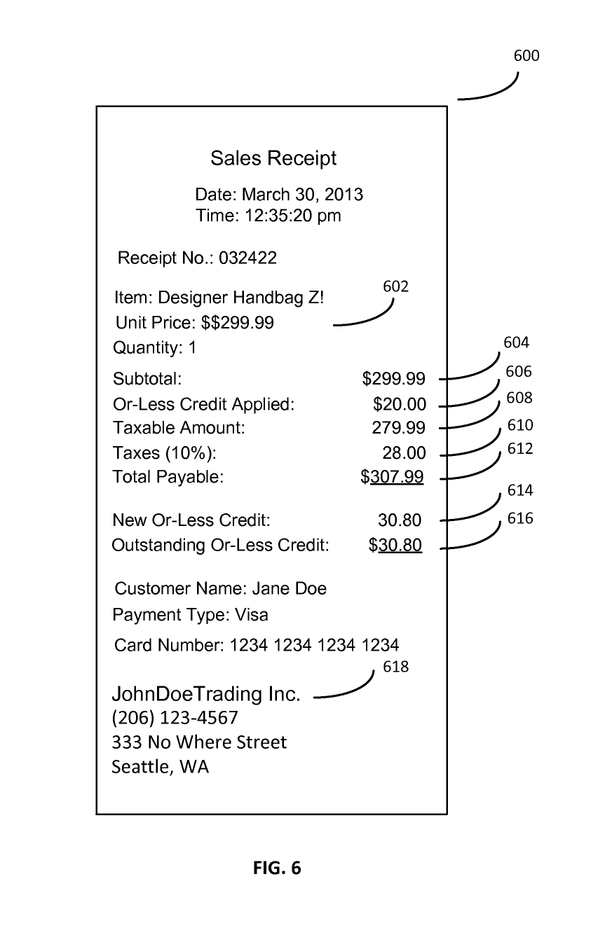

FIG. 6 is an example presentation or screenshot of a record 600 on a device coupled to a user, such as those coupled to the users as shown in FIG. 1, or of one printed on a physical medium, such as paper, in accordance with an embodiment of the present invention. According to one embodiment, an advertising system such as the advertising system 400 may generate the record 600 that associates a lower price with an item of interest, after having received or ascertained a payment or payment commitment from a customer or user such as the user 102a for the item. The record 600 comprises item and price information 602 that identifies the item, a first price, and a quantity, as well as seller information 618 that identifies the seller of the item. In one embodiment, the user may have an existing credit balance 606 (e.g., a sign-up gift from the advertising system or an outstanding credit from a previous purchase), with which the subtotal 604 of the present purchase may first be reduced. Including the taxes 610 for the reduced amount 608, the total 612 may be the total amount that the user would provide his commitment to pay or be responsible for. Upon receiving such a commitment, the advertising system may reveal a lower price for the item such as an amount 614 that is 10% off the total amount. The advertising system may assign the saving with the lower price to an account associated with the user. In another embodiment, the saving with the lower price may be refunded to the user (e.g., to his credit card or banking account). In yet another embodiment, the saving with the lower price may be realized after receiving the payment commitment and before charging the user for the item. (All modes, algorithms, or methods of price and/or discount determination are within the scope of various embodiments.)

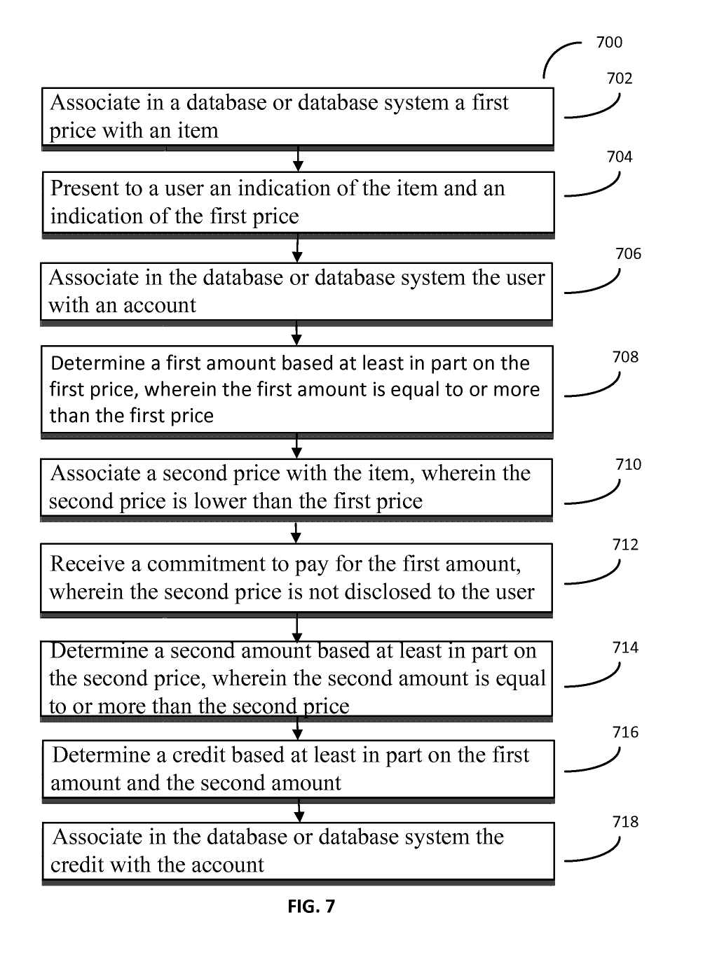

Referring to FIG. 7, a flow of an example process 700 for advertising a retail item for sale, such as one that may be executed on, in, or by an advertising system like the one shown in FIG. 1 or FIG. 4, in accordance with an embodiment of the present invention, is provided. For instance, per the example process 700, an embodiment may associate in a database (such as the database 412 in FIG. 4) a first price (e.g., a listed price) with an item, where the item and price information may come from an administrator or a third-party system via the communications interface 414, user interface 416, input handler 418, and datastore manager 424 (702). The embodiment may present to a user an indication of the item and an indication of the first price via the user interface 416, the datastore manager 424, and the response handler 420, for example, in response to user input resulting in a webpage of item and price information (704). The embodiment may associate the user with an account via the input handler 418 and the credit manager 426, for example, after the advertising system having successfully authenticated the user (706). The embodiment may determine a first amount based at least in part on the first price, wherein the first amount is equal to or more than the first price, via the response handler 420 and the datastore manager 424 (708). For example, the price store 430, the database 412, or an external system may provide information for calculating taxes, shipping charges, and/or payment processing fees based on item prices and user locations, the user locations being maintained or otherwise available at the account store or an external system. The embodiment may associate a second price with the item, wherein the second price is lower than the first price, via the credit manager 426 and the datastore manager 424 (710). For example, the price store 430, the credit store 434, the database 412, or an external system may provide information for determining the second price, such as individual prices, discount rates dependent on given time periods, locations, or items, or discount rates or amounts in relation to user profiles or accounts. The embodiment may receive, and acknowledge, a commitment to pay for the first amount, wherein the second price is not disclosed to the user, via the input handler 418 and the response handler 420 (712). For example, the input handler 418 may verify the commitment (e.g., a payment of cash, debit or credit, or a credit to an account receivable associated with the seller or marketplace of the item) against the account store 432, the database 412, or an external system. (All methods, formulas, and modes of discount generation or determination are within the scope of the various embodiments.) The embodiment may determine a second amount based at least in part on the second price, wherein the second amount is equal to or more than the second price, via the datastore manager 424 and the credit manager 426 (714). For example, the credit manager 426 may simply use the second price as the second amount, or calculate the second amount based on the second price and some other factors or information, such as delivery locations, associated tax rates, and shipping and handling choices. The embodiment may determine a credit based at least in part on the first amount and the second amount via the credit manager 426 and the datastore manager 424 (716). For example, the credit manager 426 may calculate a credit or discount amount based on the difference of the first and second amounts. The embodiment may then associate in the database the credit with the account via the credit manager 426 and the datastore manager 424 (718). For example, the credit manager 426 may record the credit or discount amount against the user account stored in the account store 432. In one embodiment, the credit manager 426 may charge the user the second amount for the item without first charging the first amount, while storing or recording in the account store 432 the credit or discount amount against the user account, or presenting to the user the credit or discount amount via a message or medium, such as an electronic statement or paper sale receipt.

Per the example process 700, item information, price information, account information, credit information, relationship information, and other application-specific information may be stored and maintained in the database 412. The user interface 416, input handler 418, response handler 420, query engine 422, datastore manager 424, and credit manager 426 may access the database 412 directly or indirectly, and perform operations in relation to the information therein. For example, the input handler 418 may cause the datastore manager 424 of the advertising system to create, search, or modify an item and its price. The input handler 418 may also cause the credit manager 428 of the advertising system to determine a lower price, generate a credit, or charge a lower price, and store the resulting data and metadata in the database 412, upon the input handler 424 having received a payment commitment from a user.

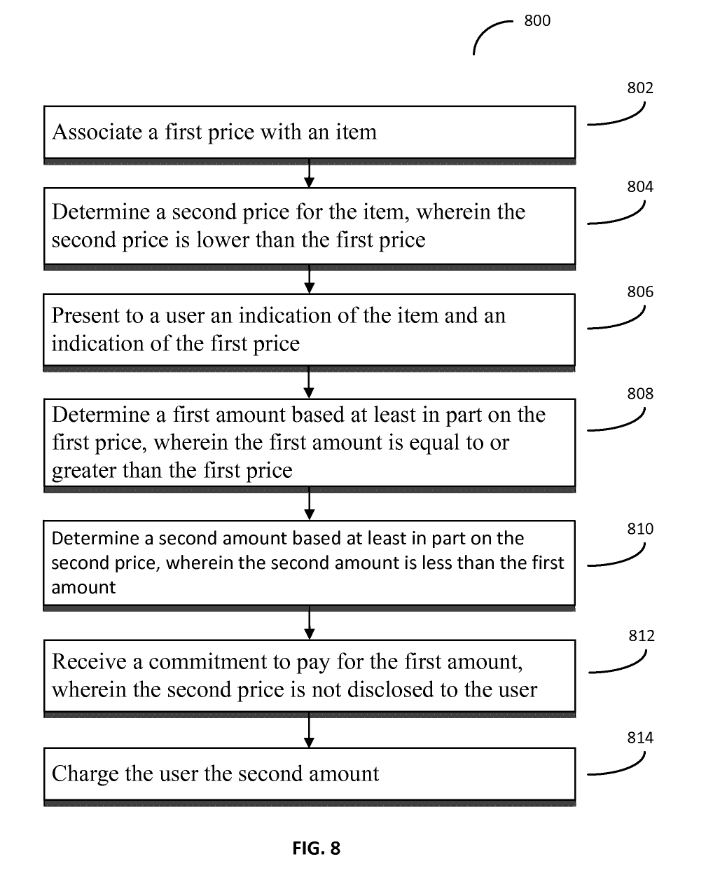

Referring to FIG. 8, a flow of an example process 800 for advertising a retail item for sale, such as one that may be executed on, in, or by an advertising system like the one shown in FIG. 1 or FIG. 4, in accordance with an embodiment of the present invention, is provided. For instance, per the example process 800, an embodiment may associate a first price with an item (802). The embodiment may determine a second price for the item, wherein the second price is lower than the first price (804). The embodiment may present to a user an indication of the item and an indication of the first price (806). The embodiment may determine a first amount based at least in part on the first price, wherein the first amount is equal to or greater than the first price (808). The embodiment may determine a second amount based at least in part on the second price, wherein the second amount is less than the first amount (810). The embodiment may receive a commitment to pay for the first amount, wherein the second price is not disclosed to the user (812). The embodiment may then charge the user the second amount (814).

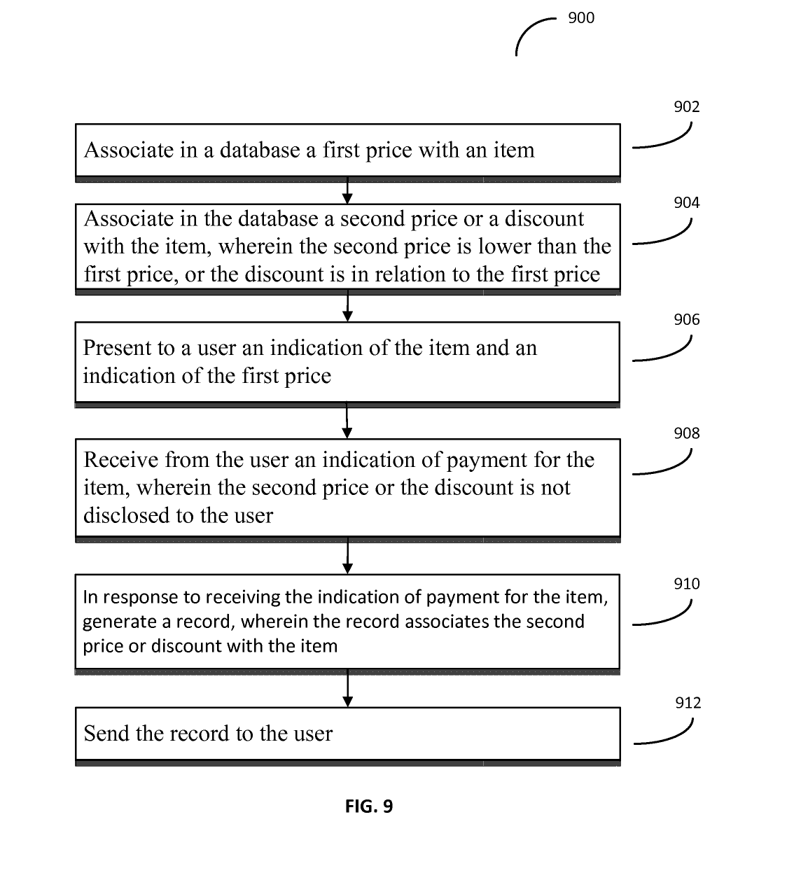

Referring to FIG. 9, a flow of an example process 900 for advertising a retail item for sale, such as one that may be executed on, in, or by an advertising system like the one shown in FIG. 1 or FIG. 4, in accordance with an embodiment of the present invention, is provided. For instance, per the example process 900, an embodiment may associate in a database a first price with an item (902). The embodiment may associate in the database a second price or a discount with the item, wherein the second price is lower than the first price, or the discount is in relation to the first price (904). The embodiment may present to a user an indication of the item and an indication of the first price (906). The embodiment may receive from the user an indication of payment for the item, wherein the second price or the discount is not disclosed to the user (908). In response to receiving the indication of payment for the item, the embodiment may generate a record, wherein the record associates the second price or discount with the item (910). The embodiment may then send the record to the user (912).

It should be appreciated that the specific steps illustrated in FIG. 7 (as well as those in FIG. 8 or FIG. 9) provide a particular method of advertising an item according to an embodiment of the present invention. Other sequences of steps may also be performed according to alternative embodiments. For instance, alternative embodiments of the present invention may perform the steps or possess the limitations outlined above in a different order. Moreover, the individual steps or limitations so illustrated may include multiple sub-steps or sub-limitations that may be performed in various sequences as appropriate to the individual step. Furthermore, additional steps or limitations may be added or removed depending on the particular applications and still fall within the scope of various embodiments. Moreover, two or more steps or limitations may be replaced by, implemented through, realized in, or accounted for a single step or limitation that comprises details that are more specific than the two or more steps or limitations. Two or more limitations of a claimed subject matter or patent claim may be replaced by, implemented through, realized, or accounted for in a single limitation, e.g., in a dependent claim, that comprises details that are more specific or narrower in scope than the two or more limitations, e.g., in an independent claim. For instance, in one embodiment, the example process 700 may comprise a step or limitation of receiving a request from the user to pay for the first amount from a credit card associated with an account of the user stored in the database without displaying the second price to the user, the step or limitation realizing, implementation, or otherwise accounting for the step or limitation of associating in the database the user with an account (706) and the step or limitation of Receive a commitment to pay for the first amount, wherein the second price is not disclosed to the user (712). In another embodiment, the example process 700 may omit or otherwise modify the step or limitation of associating in the database the user with an account (706), the step or limitation of determining the first amount based at least in part on the first price (708), and/or the step or limitation of determining the second amount based at least in part on the second price (714). In another embodiment, the process 800 may modify the step of presenting to the user the indication of the item and the indication of the first price (806) by presenting additional price information, such as a higher price for the item than the first price, with the first price being a publicly available discounted price or a reduced price specific to the user. In yet another embodiment, the example processes 700 and 800 may comprise or otherwise incorporate the steps of generating a record (810) and sending it to the user (812). One of ordinary skill in the art would recognize many variations, modifications, and alternatives. In addition, a number of embodiments of how the system, method, and process can be employed for various applications have been provided. It will be appreciated that such a system, method, or process can be adapted to accommodate other applications of advertising or electronic commerce.

For instance, in one embodiment, an advertising system, such as the advertising system 400 or one that comprises the advertising system 106 and the credit server 110, may receive a payment or a payment authorization to account for the first amount. In another embodiment, credits assigned to a user's account due to purchases via the advertising system do not expire, so that the user may use them for future purchases or request for withdrawal. In one embodiment, all users may receive the same discounts or credits when all else are equal (e.g., same item, within the same period of time, etc.), and would be formally informed of the discount or credit amounts only after the advertising system has received a payment commitment from the user. There may be no need to prevent one user from disclosing his own discount or credit amount to others. In another embodiment, the advertising system may present a request to the user and ask him to agree that he does not disclose to others the discount or credit amounts he has received from the system. The limitation of such disclosure may be limited to written records, or publication to public platforms (e.g., private messages between individuals may be allowed). The advertising system may not grant a membership or account registration unless the user agrees with the term or condition.

In one embodiment, the advertising system may not disclose or release a credit immediately or soon after its having received the commitment from the user. For example, it may notify the user of the credit amount and/or refund or realize the credit amount only after a period of time or a specific release date, which may be based on a fixed length, a calendar day or month, or an event. In another embodiment, the advertising system may notify the user of the credit amount immediately or soon after its receipt of user payment commitment, but only refund or realize the credit after a period of time, a specific release date, or an event. For example, the advertising system may prevent the user from using the otherwise known credit amount, or present him a message of denial or explanation should he request for a refund or purchase discount.

In one embodiment, the advertising system may use the credit information or amount from a newly completed purchase in accordance with an embodiment of the present invention, and apply it to items being presented to the user. For example, in response to the user′ input resulting in a plurality of items being shown on his device, the advertising system may advertise and indicate the discounted price for each item in accordance with the credit information or amount. It may group the items based on the amount of discounts (e.g., 10% off, 20% off, . . . 90% off, and free). These discounted prices may become the first price of their respective items, each being associated with yet another lower price unknown to the user. The user may provide criteria to the advertising system so that only items with specific discount rates (e.g., free, followed by 90% off, 80% off, down to 50% off) may be presented. The user may not use up all his credit balance for a subsequent purchase, which may also generate another credit whose amount may be added to the credit balance.

In one embodiment, the advertising system may encourage the user to use the credit for future purchases (or discourage him from withdrawing the credit from his account) by adding a bonus to the credit if the credit is used for a subsequent purchase via the system. There may be criteria that limits, increases, or decreases the credit bonus amount based on how quickly or when the credit is applied towards his next purchase. For example, such a credit, saving or discount may be reduced by a certain percentage (e.g., 5%) for every hour or day since the purchase that resulted the credit. Such changes to an available credit, whether time-based or otherwise, may be subject to a base amount or percentage, after which no further change shall be made. In another embodiment, such a credit, saving, or discount may be worth a larger amount for a purchase of multiple items than if the customer were to purchase these items individually or in a random sequence or order. For example, a customer may obtain a larger total discount if he purchases multiple items in a single transaction instead of multiple transactions.

In one embodiment, the advertising system may provide criteria or thresholds (e.g., a reference amount that may be common to all users or specific to a user or group of users) that the credit balance associated with a user account must fulfill or meet before the credit balance, or part thereof, may be applied to purchases of items, withdrawn, or transferred (e.g., to another account such as that of a charity or another user). For example, the credit balance may be available for use upon the next statement state associated with the account. In another embodiment, the advertising system may provide other criteria or thresholds, such as a minimum number of the same or different items, or a specific set of items. In yet another embodiment, the advertising system may determine a hidden discount or lower price for a single transaction or payment commitment based on some criteria or thresholds, such as a minimum number of the same or different items, a specific set of items, or a specific sales event. The advertising system may assign or otherwise associate a part or portion of the resultant credit or discount to or with one or more items in the transactions, thereby accounting for the total amount of the resultant credit or discount.

In one embodiment, the advertising system may provide criteria or thresholds in relation to a plurality of users for realizing a credit or discount. For example, it may provide a reference count and a current count, where the current count tracks the number of different users making purchases for any item, a specific item, or a specific set of items, via the system. When the current count meets or exceeds the reference count, then all the individual credits associated with these different users may be realized. In another embodiment, the advertising system may provide criteria or thresholds in relation to a non-user account (e.g., a charity) or a user group (e.g., an open group), which may involve a criterion or threshold amount and/or number. For example, the advertising system may offer a hidden discount or credit for a group of a certain number of participating users (e.g., a minimum of 5) who would make a combined purchase of a certain amount (e.g., a threshold $10,000). When the participating users have successfully met the group size requirement and the total purchase threshold, the non-user account associated with this user group would be assigned, or the individual user accounts associated with this user group would receive proportionally, the realized credit amount, which has remained unpublished to these participating users until they complete their purchases. In one embodiment, individual discounts are disclosed upon receipt of their individual payment commitments. In another embodiment, no discounts are disclosed until the participating users have submitted all contributing payment commitments. In one embodiment, a user in such a user group may invite other users to join. In another embodiment, any user may join such a user group.

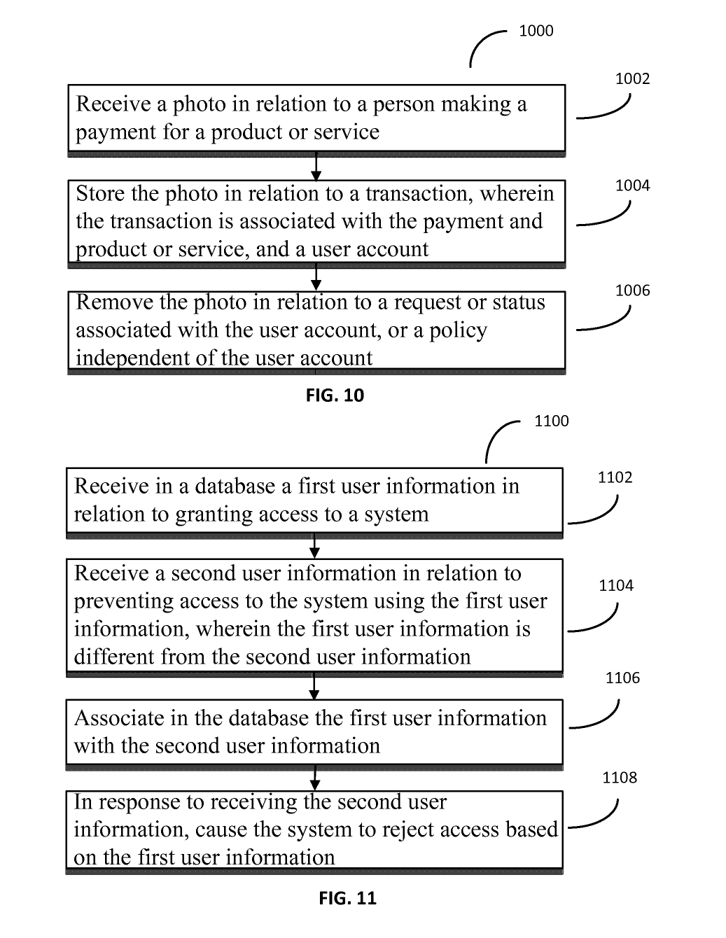

In one embodiment, a group of users may contribute their individual credits or savings towards a group credit or saving, which can be used by any user in the group or by another group of users. For example, a couple associated with a charitable group may make purchases via their respective accounts that accumulate a credit amount, where the credit amount is not only accessible to the couple, but also to the charitable group. To provide a mechanism, way, or means to deter fraudulent use of the available fund, an embodiment may receive a photo of the person making use of the fund. For instance, referring to FIG. 10, a flow of an example process 1000 for creating a record of transaction with identification of the buyer or payer, such as one that may be executed on, in, or by one or more devices and computer systems like the one shown in FIG. 1 and/or FIG. 4, in accordance with an embodiment of the present invention, is provided. (Such a mechanism, way or means may also be employed or otherwise adapted for making a payment in general, such as for a purchase of a good or service.) For instance, per the example process 1000, a server such as the credit server 110 may receive a photo in relation to a person making a payment for a product or service (1002), wherein the payment may be remitted using a credit or balance available in a user account. For example, a cashier may take a photo of a customer via a point-of-sale terminal or system when the customer is making a payment for a product or service, and then send it to the credit server 110. Alternatively, a customer's own device such as the device 104a shown in FIG. 1 may capture the image of the customer, for example, when the customer is paying for a product or service via his own device, such as one capable of mobile or proximity-based payment which may involve near-field communication (NFC) and/or fingerprint authentication. The credit server 110 may store the photo in relation to a transaction, wherein the transaction is associated with the payment and product or service, as well as a user account (1004). For example, the point-of-sale terminal or system may send the credit server 110 information about the amount of the payment, time of the payment, the product or service, and an identification of the account making the payment, in addition to the photo or image, so that the credit server 110 may log a transaction against the account and associate the photo or image with the transaction. In one embodiment, such an image or photo is not stored or maintained at any server or database associated with the seller. For example, the image or photo may be sent to a server associated with a service provider responsible for providing an account statement in relation to the account where the money for making the payment is from. In another embodiment, an operator of the point-of-sale terminal or system may obtain the image, for example, for checking if the photo is indeed of a live person or of a person standing in front of him, and the image would become unavailable to the operator or the seller when the transaction is complete. The credit server 110 may then remove the photo or image in relation to a request or status associated with the user account, e.g., a user of the account requesting that the image be removed, or upon the next statement date, or in relation to a policy independent of the user account. e.g., per some government policy (1006). In one embodiment, a user of the account may receive a statement of account activity that lists each transaction with an image of payer or buyer. The user may confirm the payment thereby removing permanently the image from the credit server 110 or the database where the image is stored. The user may report fraudulent use of his account when he sees an image of an unauthorized payer. In another embodiment, a photo of the payer may be part of an electronic receipt sent to a user associated with the account (e.g., via an email or SMS). In another embodiment, an account holder may not have access to the image of a buyer or payer unless he reports to the service provider (e.g., a credit card company) of the account that he suspects the transaction might be fraudulent.

In one embodiment, a credential or identification such as a password, passcode, fingerprint representation may invalidate or otherwise remove another password, passcode, fingerprint representation that was previously accepted for access to device, system, or service. For instance, referring to FIG. 11, a flow of an example process 1100 for invalidating a user credential or identification with another user credential or identification, such as one that may be executed on, in, or by one or more devices and computer systems like those shown in FIG. 1 and/or FIG. 4, in accordance with an embodiment of the present invention, is provided. For instance, per the example process 1100, a device such as the device 104a may receive and store a first user information, e.g., user-provided data such as a passcode or a biometric such as a fingerprint or its representation, in relation to granting access to the device (1102), such as when a user creates a passcode or fingerprint record via a user interface on the device. The device may receive a second user information in relation to preventing access to the device, wherein the second user information is different from the first user information (1104), such as when the user creates a different passcode or fingerprint record via the user interface on the device. For example, when the user provides the same passcode or fingerprint for invalidating or otherwise cancelling the access-granting passcode or fingerprint input earlier by the user, the device may prompt the user with an error message and reject the entry. In an embodiment, different types of user identification or credential may be used to invalidate, remove, or cancel other access-granting identification or credential, such as a passcode to cancel a fingerprint record. In another embodiment, the same type must be used, such as a fingerprint to cancel another fingerprint record. The device may then associate in a database local to the device or external to it via a network the first use information with the second user information (1106). This enables a lookup of future input or entry of user identification or credential against the available user identifications and credentials in the database, and decide if the user intends to gain access to the device or revoke a user identification or credential based on the input or entry. For instance, in response to receiving the second user information (e.g., information based on the user providing an imprint of his right-thumb fingerprint on a fingerprint reader on the device), the device may cause the removal of the first user information (e.g., the user's left-thumb fingerprint record) from the database (1108). In one embodiment, the same user interface screen, prompt, and/or message in relation to granting access to a device or computer system may be presented to a user who may enter or provide the second user information (e.g., a credential-revoking fingerprint or passcode) to revoke or remove an access-granting identification or credential to the device or computer system. In one embodiment, where multiple users may access and use a common device (e.g., a mobile device capable of making electronic payments or accessing to a debit or credit account), a device equipped with one aspect of such a one-step credential revocation capability may allow the administrator or owner of the device to set up a so-called master revocation credential, which may be associated with one or more credentials, each being associated with one or more users of the device, including the administrator or owner himself. In one embodiment, the master revocation credential only needs to be different from the access-granting identification(s) and credential(s), if any, associated with the administrator or owner. Upon receiving successfully the master revocation credential (e.g., a fingerprint information of the administrator of the device), the device may then revoke access based on the access-granting identifications and credentials associated with the master revocation credential, such as by removing them from the database. In one embodiment, the master revocation credential may also be removed upon removal or cancellation of its associated access-granting identifications and credentials. In another embodiment, a master revocation credential remains intact upon such removal or cancellation, and it may be associated with new access-granting identifications and credentials.

In one embodiment, the advertising system may allow a user to gift his credit to another user or his account. For example, the user may send a request to the advertising system, the request comprising the amount (less than or equal to his credit balance), and an identification of the recipient user. The system would then transfer the specified amount from the sender's account to the recipient's account. In another embodiment, the system may add a bonus amount to the original gift amount, so to encourage social sharing and promotion. In another embodiment, such a gifted amount may reduce the listed prices (or the first prices) of items that are presented to the recipient user, even when he has not made via the system any purchase in relation to the gifted amount.

In one embodiment, the advertising system may enable a user to purchase an item and send it to another user, or a person not having an account with the system, along with a receipt showing the first price while the user only paid the second price for the item. In another embodiment, there may exist a plurality of such advertising systems, whereby credits resulted from purchases via one advertising system may be used or otherwise applied to purchases via another advertising system. For example, these advertising systems may share common account store and/or access user and credit information through a common membership system or user account service.

In one embodiment, the advertising system may enable a user to assign a credit from a purchase, or part thereof, to a non-user account, such as one for charity. For example, in response to receiving a commitment to pay for an item from the user, the system may present the user an indication of the non-user account and an indication of the credit. It may also present an input receiver with which the user may indicate if or how much he wishes to transfer the credit from the purchase, or part thereof, to the non-user account. The system may then act accordingly. For example, the user may operate an input receiver (e.g., a graphical user interface slide bar) on his device to allocate 50% of the credit amount to the non-user account, and the system would then credit 50% of the amount to the non-user account, and the rest to the user's own account. In another embodiment, the advertising system may stipulate an automatic deduction of a credit, such as a fixed percentage, a fixed amount, or an amount depending on the credit amount, such as rounding it down to its nearest dollar amount, with the difference being the donation.

In another embodiment, a range of discounts or lower prices may be published or otherwise presented to a consumer prior to his commitment to pay a higher amount for a product or service. The resulting charge may be determined based at least in part on this range. In another embodiment, different ranges of discounts or lower prices may be associated with different quantities or bundles of the same product(s) or service(s). In one embodiment, an online marketplace or platform embodying an aspect of the present invention may enable a seller to select a range (e.g., 10% to 50% off) or group (e.g., 10%, 20%, 30%) of discounts, savings or credits, and associate the range or group with a product or service, so that the online marketplace or platform may provide a discount, saving, or credit within the bounds of this range of group to a user who has indicated a commitment to pay for the product or service. In one embodiment, the range or group of discounts is not disclosed to the user prior to his commitment to pay. In another embodiment, the seller may let the online marketplace or platform decide how much discount, saving, or credit within the range or group be associated with a purchase of an item or service. Such association may be based on random selection, an algorithm, a manual intervention, or some other methods. In yet another embodiment, the seller may specify the range or group of discounts, savings or credits.

In one embodiment, a discount may be provided without the need of a credit or partial refund. For instance, a point-of-sale terminal, device or system embodying an aspect of the present invention may present a customer with an electronic or paper receipt identifying a discount for a product upon receiving a commitment to pay a price without the discount. In another embodiment, the customer might not even be aware or certain that a particular product or service is associated with a discount. For example, a department store may accept a credit card or cash payment from a customer for the listed price or sales price of an item, and charge the customer less than the listed price or sale price without prior notice. The customer may receive a receipt that indicates the discount amount and an indication (e.g., on the receipt, by the cashier, or via the point-of-sale terminal) that indicates this is an unpublished discount or a similar message.

In another embodiment, in lieu of or in addition to a monetary credit, discount, saving, or gift, a non-monetary kind may be provided, such as an additional warranty, frequent flyer points, free shipping, and so on. In one embodiment, such a “post-payment commitment” monetary or non-monetary credit, discount, saving or gift may be made available only to a group of users who, for example, belong to a membership that requires a monthly or annual fee. In one embodiment, at least a part of such a membership fee is refundable to a user or member should his total saving or credit over a given period of time is less than the membership fee or some other amount. In one embodiment, an indication of a member-only credit, discount, saving or gift unknown prior to commitment to pay may be associated with a retail product or service, for example, an icon next to a price for a particular product or service on an online webpage. In one embodiment, when a user indicates his commitment to pay a price for a product or service, he would receive an indication of a lower price and be charged for the lower price or an amount based on the lower price (e.g., including sale taxes and shipping and handling costs). In another embodiment, there may not be any indication of “surprise” discount or saving in relation or connection to the price or the product or service. For example, one or more computer system of an online service, the one or more computer systems configured with executable instructions, such as a travel website, may present a price for a flight or hotel booking of interest to a user, who decides to purchase it by providing his account and/or credit information to the website. The website may then present him another price which is lower than the price, and charge his account or credit card based on the other price for his purchase of the product or service. In some instance, this approach may help promote the website as a whole instead of or in addition to individual products or services.

While the embodiment(s) described above may make reference to specific hardware and software components, methods, and structures, as well as organizations and arrangements thereof, those skilled in the art will appreciate that different modifications, adaptations, combinations, variations, and distributions of hardware components, software components, methods, and/or structures may also be used, and that particular operations described as being implemented in hardware might also be implemented in software or vice versa. All such modifications, adaptations, combinations, variations, and distributions that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiment(s) illustrated. For instance, method steps described herein may be performed in alternative orders or in parallel. Various embodiments of the invention include logic stored on non-transitory computer readable media, the logic configured to perform methods of the invention. The examples provided herein are exemplary and are not meant to be exclusive. (For example, any example with specific references to product may apply to service.)

In addition, embodiments of the present invention may be realized using any combination of dedicated components and/or programmable processors and/or other programmable devices. Furthermore, computer programs incorporating various features of the present invention may be encoded on various non-transitory computer readable media for storage and/or communication; suitable media include magnetic disk or tape, optical storage media such as compact disk (CD) or DVD (digital versatile disk), flash memory, hard drive, and any other computer readable medium. Computer readable media encoded with the program code may be packaged with a compatible device or provided separately from other devices (e.g., via Internet download). Likewise, the invention, or certain aspects or portions thereof, may be embodied in propagated signals, or any other machine-readable communications medium. Where the program code is loaded into and executed by a machine, such as a computer, the machine becomes an apparatus configured for practicing the disclosed embodiments. In addition to the specific implementations explicitly set forth herein, other aspects and implementations will be apparent to those skilled in the art from consideration of the specification disclosed herein. It is intended that the specification and illustrated implementations be considered as examples only.

Thus, although the invention has been described with respect to specific embodiments, it will be appreciated that the invention is intended to cover all modifications and equivalents within the scope of any relevant claims.

What is claimed is:

1. A computer-implemented method for advertising, the method comprising, by a computer system:
associating in a database a first price with an item;
presenting to a user an indication of the item and an indication of the first price;
associating in the database the user with an account;
determining a first amount based at least in part on the first price, wherein the first amount is equal to or more than the first price;
associating a second price with the item, wherein the second price is lower than the first price;
receiving a commitment to pay for the first amount, wherein the second price is not disclosed to the user;
determining a second amount based at least in part on the second price, wherein the second amount is equal to or more than the second price;
determining a credit based at least in part on the first amount and the second amount; and
associating in the database the credit with the account.

2. The method of claim 1, wherein:
receiving a commitment to pay the first amount comprises receiving a payment to account for the first amount;
presenting to the user the indication of the item and the indication of the first price comprises presenting to the user the indication of the item, the indication of the first price, and an indication of a lower price, wherein the lower price is not revealed; and
associating the second price with the item comprises associating in the database a percentage with the item, whereby the second price may be determined based on the percentage and the first price.

3. The method of claim 1, further comprising:
presenting to a second user an indication of the item and an indication of the first price;
associating in the database a second account with the second user;
receiving a commitment to pay for the first amount from the second user, wherein the second user does not know the second price; and
associating in the database the credit with the second account, wherein there is no expiry associated with the credit being associated with the second account.

4. The method of claim 1, further comprising:
presenting to the user a request that the user will not disclose the credit in any written record; and
receiving from the user an indication of an agreement that the user will not disclose the credit publicly.

5. The method of claim 1, further comprising:
determining a time interval;
determining a release date based at least in part on the time interval and the time of receiving the commitment to pay for the first amount;
presenting to the user an indication of the credit; and
wherein associating in the database the credit with the account comprises associating in the database the credit with the account at or after the release date.

6. The method of claim 5, wherein presenting to the user the indication of the credit comprises presenting to the user the indication of the credit at or after the release date.

7. The method of claim 1, further comprising:
determining a time interval;
determining a release time based at least in part on the time interval and the time of receiving the commitment to pay for the first amount;
presenting to the user an indication of the credit; and
receiving from the user a request to remove from the account a sum less or equal to the credit; and
in response to receiving the request to withdraw a sum less or equal to the credit before the release date, sending the user an indication of denial.

8. The method of claim 1, further comprising:
associating a third price with a second item;
determining a fourth price based on the credit and the third price, wherein the fourth price is lower than the third price;
associating the fourth price with the second item; and
presenting to the user an indication of the second item, an indication of the third price, and an indication of the fourth price, wherein the fourth price includes a zero amount or a percentage discount of the third price.

9. The method of claim 8, wherein determining the fourth price based on the credit and the third price comprises:
determining a second credit based at least in part on the credit, wherein the second credit is more than the credit; and
determining the fourth price based on the second credit and the third price.

10. The method of claim 8, further comprising:
determining a third amount based on the fourth price;
determining a fifth price in relation to the second item, where the fifth price is lower than the fourth price;
determining a fourth amount based at least in part on the fifth price;
receiving an indication of commitment to pay for the third amount from the user, wherein the user does not know the fifth price;
determining a second credit based at least in part on the fourth amount and the third amount;
determining a deduction amount based at least on the credit and the third amount; and
in response to receiving the indication of commitment to pay for the third amount, reduce the credit by the deduction amount and associate the second credit with the account.

11. The method of claim 1, further comprising:
determining a reference amount;
associating in the database a balance with the account, wherein the balance includes zero;
determining that the balance plus the credit is equal to or more than the reference amount; and
wherein associating the credit with the account comprises associating another credit with the account, the other credit comprising the balance and the credit.

12. The method of claim 1, further comprising:
determining a reference count;
associating in the database a current count with the account;
incrementing the current count by one; and
determining that the current count is equal to or more than the reference count.

13. The method of claim 1, further comprising:
associating in the database a reference count;
associating in the database a current count;
in response to receiving a commitment to pay for the first amount from the first user, incrementing the current count by one;
presenting to a second user an indication of a second item and an indication of a third price, wherein the second item is not the item;
associating in the database a second account with the second user;
determining a third amount based at least in part on the third price, wherein the third amount is equal to or more than the third price;
determining a fourth price in relation to the third price, wherein the fourth price is lower than the third price;
receiving a commitment to pay for the third amount from the second user, wherein the second user does not know the fourth price;
determining a fourth amount based at least in part on the fourth price, wherein the fourth amount is equal to or more than the fourth price;
in response to receiving the commitment to pay for the third amount from the second user, incrementing the current count by one;
determining that the current count is equal to or greater than the reference count;
determining a second credit based at least in part on the third amount and the fourth amount; and
wherein associating in the database the credit with the account comprises associating in the database the credit with the account and the second credit with the second account in response to determining that the current count is equal to or greater than the reference count.

14. The method of claim 13, further comprising:
associating in the database a reference amount;
associating in the database a current amount with a group, wherein the current amount includes zero;
associating in the database the user with the group;
receiving a request from the second user to join the group;
in response to receiving the request from the second user to join the group, associating in the database the second user with the group;
wherein associating in the database the current count comprises associating in the database the current count with the group;
in response to receiving the commitment to pay for the first amount from the user, increasing the current amount by the credit;
in response to receiving the commitment to pay for the third amount from the second user, increasing the current amount by the second credit;
determining that the current amount equals to or exceeds the reference amount; and
wherein associating in the database the credit with the account and the second credit with the second account in response to determining that the current count is equal to or greater than the reference count comprises associating in the database the credit with the account and the second credit with the second account, in response to determining that the current count is equal to or greater than the reference count, and in response to determining that the current amount equals to or exceeds the reference amount.

15. The method of claim 1, further comprising:
associating in the database a credit balance with the account, wherein the credit balance includes zero;
associating in the database a second user with a second account;
receiving from the user a request to associate a gift amount with the second user;
determining a second credit based at least in part on the gift amount, wherein the second credit is larger than the gift amount;
wherein associating in the database the credit with the account comprises adding in the database the credit to the credit balance associated with the account;
determining that the gift amount is equal or less than the credit balance; and
in response to receiving from the user a request to associate the gift amount with the second user, subtracting the gift amount from the credit balance associated with the account, and associating the second credit with the second account.

16. The method of claim 1, further comprising:
associating in the database a second account, wherein the second account includes a charity account;
in response to receiving the commitment to pay for the first amount from the user, presenting an indication of the second account and an indication of the credit to the user;
receiving an indication from the user that he does not want to associate the credit with the second account; and
wherein associating in the database the credit with the account comprises associating in the database the credit with the account in response to receiving an indication from the user that he does not want to associate the credit with the second account.

17. The method of claim 1, further comprising:
associating in the database a second account, wherein the second account includes a charity account;
in response to receiving the commitment to pay for the first amount from the user, presenting an indication of the second account and an indication of the credit to the user;
receiving an indication from the user that he wants to associate a gift amount with the second account, wherein the gift amount is equal to or less than the credit; and
in response to receiving the indication from the user that he wants to associate the gift amount with the second account, reduce the credit by the gift amount; and
wherein associating in the database the credit with the account comprises associating in the database the reduced credit with the account and the gift amount with the second account.

18. The method of claim 17, further comprising:
in response to receiving the indication from the user that he wants to associate the gift amount with the second account, determining a bonus amount; and
wherein associating in the database the reduced credit with the account and the gift amount with the second account comprises associating in the database the reduced credit with the account and the gift amount and the bonus amount with the second account.

19. A method comprising:
under control of one or more computer systems of an online service, the one or more computer systems configured with executable instructions,
presenting to a user an indication of a first price and an indication of a product or service, wherein the user is associated with an account of the online service;
receiving from the user an indication of a commitment to pay for the first price in relation to the product or service;
in relation to receiving from the user the indication of the commitment to pay for the first price, presenting to the user an indication of a discount or a second price, wherein the second price is lower than the first price; and
charging the account based at least on the discount or the second price.

20. A computer-implemented method for advertising, the method comprising, by a computer system:
associating in a database system a first price with an item;
associating in the database system a second price or a discount with the item, wherein the second price is lower than the first price, or the discount is in relation to the first price;
presenting to a user an indication of the item and an indication of the first price;
receiving from the user an indication of payment for the item, wherein the second price or the discount is not disclosed to the user;
in response to receiving the indication of payment for the item, generating a message, wherein the message associates the second price or the discount with the item; and
presenting the message to the user.
